(19) United States
(12) Patent Application Publication
(10) Pub. No.: US 2026/0227936 A1
(43) Pub. Date: Aug. 6, 2026

(54) IMAGE FORMING APPARATUS, CONTROL METHOD THEREFOR, AND STORAGE MEDIUM STORING CONTROL PROGRAM THEREFOR

(71) Applicant: CANON KABUSHIKI KAISHA, Tokyo (JP)

(72) Inventor: Takaaki YANO, Tokyo (JP)

(21) Appl. No.: 19/436,113

(22) Filed: Dec. 30, 2025

(30) Foreign Application Priority Data
Feb. 4, 2025 (JP) 2025-016857

(51) Int. Cl. G06F 3/12

(52) U.S. Cl. CPC G06F 3/1205; G06F 3/1218; G06F 3/1253; G06F 3/1273; G06F 3/1286; G06F 3/1288

(57) ABSTRACT

An image forming apparatus capable of separating pieces of environmental load information about printing operations having different printing purposes. The image forming apparatus includes a memory device that stores a set of instructions, and at least one processor that executes the set of instructions to obtain data to be print, determine whether to print the data under a first print condition or a second print condition that is capable of printing printed matter used more publicly than printed matter printed under the first print condition, generate first operating information about an operation status of the image forming apparatus under the first print condition when it is determined to print under the first print condition, and generate second operating information about an operation status of the image forming apparatus under the second print condition when it is determined to print under the second print condition.

### BACKGROUND

### Field of the Technology

The aspect of the embodiments relates to an image forming apparatus, a control method therefor, and a storage medium storing a control program therefor.

### Description of the Related Art

In recent years, print systems capable of coping with diversified printing needs have been constructed. A print system includes, for example, an information processing apparatus such as a PC and an image forming apparatus such as an MFP disposed in an office, and a print server such as a DFE (Digital Front End) communicably connected to the information processing apparatus and the image forming apparatus. The print system can perform printing of office documents such as internal documents used in an office (hereinafter referred to as an “office document printing operation”) and printing of external documents such as business cards and pamphlets used outside the office (hereinafter referred to as an “in-house printing operation”). In the office document printing operation, print data from the information processing apparatus is subjected to an RIP process in the image forming apparatus and is printed by the image forming apparatus. In the in-house printing operation, print data from the information processing apparatus is subjected to the RIP process in a print server and printed by the image forming apparatus.

In addition, recent print systems notify users in an office of environmental load information related to an environmental load in printing. This makes each user conscious of suppression of environmental load, and activates a movement to encourage a more environment friendly action. The environmental load information is obtained by quantifying how much resources can be saved by, for example, double-sided printing, page combination printing, monochrome printing, or the like, compared to a case where printing is performed with normal settings. For example, Japanese Patent Laid-Open No. 2012-161023 (JP 2012-161023A) discloses a technique of displaying the number of sheets output by printing in an image forming apparatus for each user to make the user aware of saving of sheets.

However, when the technique disclosed in the above publication is applied to the print system capable of the office document printing operation and the in-house printing operation, the environmental load information obtained by integrating both the printing operations is displayed. Since the office document printing operation and the in-house printing operation have different printing purposes, concepts about the environmental load information are also different. In the office document printing, it is preferable to switch to a print setting that is more environmentally friendly. In contrast, in the in-house printing operation, the quality of printed matter tends to be more important than switching to the print setting in consideration of the environment.

### SUMMARY

The present disclosure provides an image forming apparatus, a control method therefor, and a storage medium storing a control program therefor, which are capable of separating pieces of environmental load information about a plurality of printing operations having different printing purposes.

Accordingly, an aspect of the embodiments provides an image forming apparatus capable of printing, including a memory device that stores a set of instructions, and at least one processor that executes the set of instructions to: obtain data to be print, determine whether to print the data under a first print condition or a second print condition that is capable of printing printed matter used more publicly than printed matter printed under the first print condition, generate first operating information about an operation status of the image forming apparatus under the first print condition in a case where it is determined to print under the first print condition, and generate second operating information about an operation status of the image forming apparatus under the second print condition in a case where it is determined to print under the second print condition.

Features of the present disclosure will become apparent from the following description of embodiments with reference to the attached drawings. The following description of embodiments is described by way of example.

### BRIEF DESCRIPTION OF THE DRAWINGS

FIG. 1 is a view illustrating an outline of an image forming system (a print system) related to a first embodiment.

FIG. 2 is a block diagram illustrating an example of a hardware configuration of an image forming apparatus.

FIG. 3 is a block diagram illustrating an example of a hardware configuration of a print server.

FIG. 4 is a block diagram illustrating an example of a hardware configuration of a client PC.

FIG. 5A, FIG. 5B, and FIG. 5C are block diagrams illustrating examples of software configurations of the image forming system.

FIG. 6 is a view illustrating an example of a table in which pieces of information related to print jobs recorded by a print information recording module of the image forming apparatus are summarized.

FIG. 7 is a view illustrating an example of an environmental load information screen displayed in the image forming apparatus.

FIG. 8 is a flowchart illustrating a process executed by the client PC during an office document printing operation.

FIG. 9 is a flowchart illustrating a process executed by the print server during an in-house printing operation.

FIG. 10 is a flowchart illustrating a process executed by the image forming apparatus.

FIG. 11 is a flowchart illustrating a process executed in a step S1008 (subroutine) in the flowchart illustrated in FIG. 10.

FIG. 12 is a flowchart illustrating a process executed by an image forming apparatus related to a second embodiment.

FIG. 13 is a view illustrating an example of a print setting screen.

### DESCRIPTION OF THE EMBODIMENTS

Hereinafter, embodiments of the present invention will be described in detail with reference to the drawings. However, configurations described in the following embodiments are merely examples, and the scope of the present invention is not limited by the configurations described in the embodiments. For example, each unit constituting the present invention can be replaced with any configuration capable of exhibiting the same function. In addition, an arbitrary constituent may be added. Any two or more configurations (features) of the embodiments can be combined.

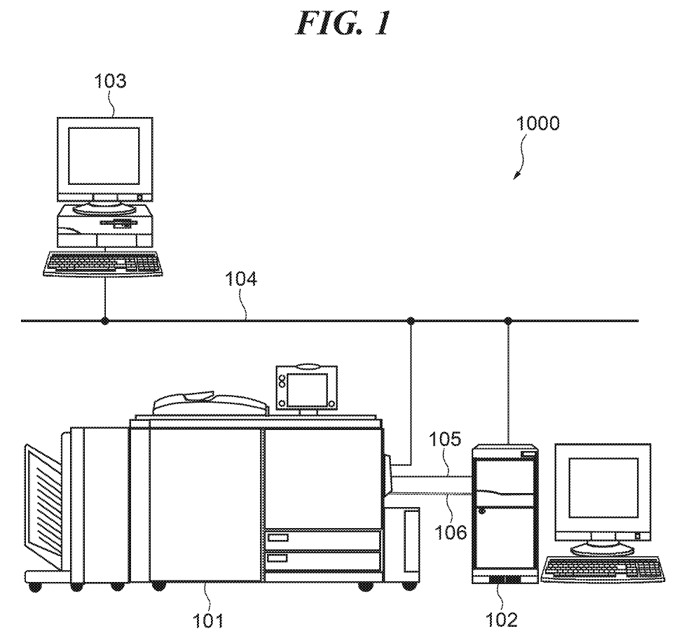

Hereinafter, a first embodiment will be described with reference to FIG. 1 to FIG. 11. FIG. 1 is a view illustrating an outline of an image forming system (a print system) 1000 related to the first embodiment. As illustrated in FIG. 1, the image forming system 1000 includes an image forming apparatus 101, a print server 102, and a client PC 103. The image forming apparatus may be referred to as, for example, a multifunction peripheral or an MFP. The print server may also be referred to as, for example, an image process controller, a digital front end (DFE), or an external controller. The image forming apparatus 101 and the print server 102 are communicably connected via an internal LAN 105 and a video cable 106. The print server 102 and the client PC 103 are communicably connected to each other via an external LAN 104. The image forming apparatus 101 and the client PC 103 are also communicably connected via the external LAN 104. In the image forming system 1000, a print instruction is directly issued from the client PC 103 to the image forming apparatus 101 via a printer driver. In the image forming system 1000, a print instruction is issued from the client PC 103 to the print server 102 via a print management application or the like.

A printer driver is installed in the client PC 103. The printer driver has a function of converting print data into a print description language that can be processed by the image forming apparatus 101. The user can issue a print instruction from various applications via the printer driver on the client PC 103. Then, the printer driver generates print data on the basis of the print instruction. The print data is sent to the image forming apparatus 101.

A print management application is installed in the print server 102. The print management application is an operation application to process the print data in the print server 102. When a print instruction is given from the print management application in response to a user operation, the print server 102 executes data analysis and an RIP process such as a rasterization process, transmits the print data to the image forming apparatus 101 together with the print instruction. The print server 102 transmits print job information data to the image forming apparatus 101 via the internal LAN 105, and transmits post-RIP image data that has been subjected to the RIP process to the image forming apparatus 101 via the video cable 106. The print management application may be installed in the client PC 103. In such a case, the user can issue a print instruction via the print management application. The print management application transmits the print data to the print server 102 on the basis of the print instruction.

When receiving the print instruction from the client PC 103 via the printer driver, the image forming apparatus 101 executes the data analysis and the RIP process and performs printing. The image forming apparatus 101 also performs printing when receiving print data or post-RIP image data from the print server 102.

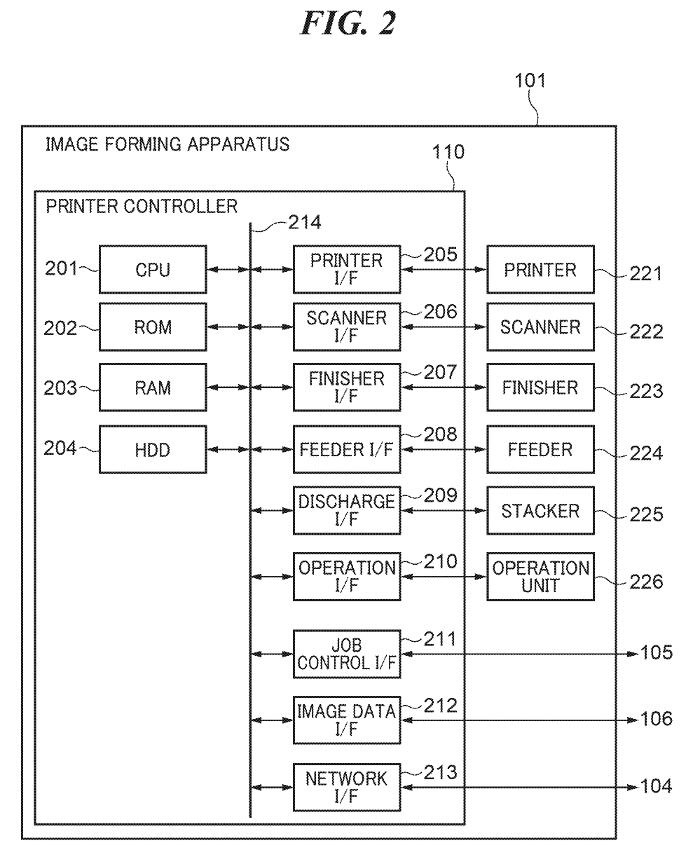

FIG. 2 is a block diagram illustrating an example of a hardware configuration of the image forming apparatus. As illustrated in FIG. 2, the image forming apparatus 101 includes a printer controller (control unit) 110, a printer 221, a scanner 222, a finisher 223, a feeder 224, a stacker 225, and an operation unit 226. The printer 221 executes a print process. The scanner 222 scans a document. The finisher 223 performs finishing processes, such as stapling, punching, and saddle stitching, on printed sheets according to various settings. The feeder 224 stores print sheets. Printed sheets are discharged and stacked on the stacker 225. The operation unit 226 receives various operations to the image forming apparatus 101 and displays information about the image forming apparatus 101.

The printer controller 110 has a CPU 201, a ROM 202, a RAM 203, and an HDD 204. The printer controller 110 includes a printer I/F 205, a scanner I/F 206, a finisher I/F 207, a feeder I/F 208, a discharge I/F 209, and an operation I/F 210. Further, the printer controller 110 includes a job control I/F 211, an image data I/F 212, and a network I/F 213. These hardware components included in the printer controller 110 are communicably connected to each other via a system bus 214.

The CPU 201 is a computer that totally controls each of the hardware components connected to the system bus 214 based on a control program stored in the ROM 202 or the HDD 204. The control programs include a program that causes the CPU 201 to execute a process (a control method for an image forming apparatus) described later. The RAM 203 functions as a main memory, a work area, etc. of the CPU 201.

Memory capacity of the RAM 203 can be expanded by connecting an optional RAM to an expansion port (not shown). The HDD 204 also stores, for example, a boot program, various applications, font data, a user file, an edit file, and the like. The image forming apparatus 101 can employ an SD card or a flash memory instead of the HDD 204.

The printer I/F 205 controls image output to the printer 221. The scanner I/F 206 controls a scanning operation of the scanner 222. The finisher I/F 207 controls the finishing process in the finisher 223. The feeder I/F 208 controls a sheet feed operation of the feeder 224. The discharge I/F 209 controls a sheet discharge operation of the stacker 225. The operation I/F 210 controls image display and reception of a user operation on the operation unit 226 . The job control I/F 211 is connected to the internal LAN 105 and transmits and receives information necessary for print control to and from the print server 102. The image data I/F 212 is connected to the video cable 106 capable of transmitting and receiving video signals, and receives post-RIP image data that has been subjected to the RIP process by the print server 102. The post-RIP image data may be received via the internal LAN 105. The network I/F 213 is connected to the external LAN 104 and controls communication with the client PC 103 or the like.

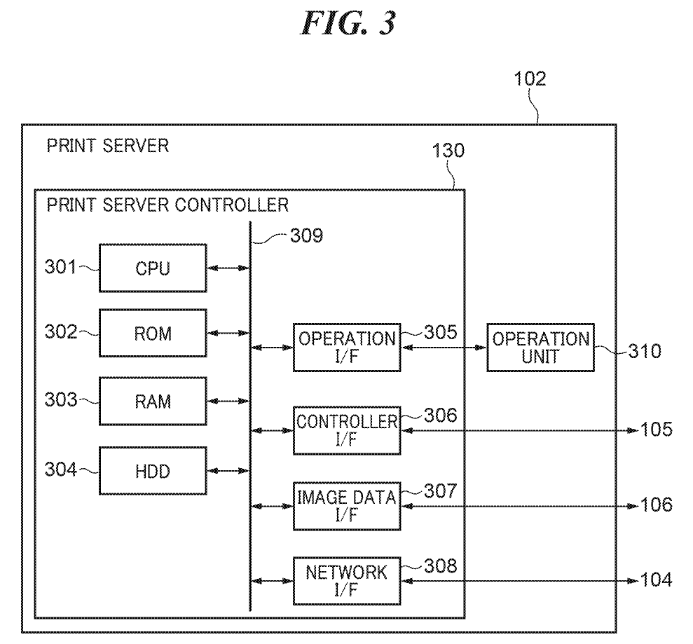

FIG. 3 is a block diagram illustrating an example of a hardware configuration of the print server 102. As shown in FIG. 3, the print server 102 includes a print server controller 130 and an operation unit 310, which are communicably connected to each other. The operation unit 310 receives various operations to the print server 102 and displays information about the print server 102. The print server controller 130 can perform analysis of a print job and rendering to image data that are necessary for executing the print process in the image forming apparatus 101. The print server controller 130 includes a CPU 301, a ROM 302, a RAM 303, and an HDD 304. The print server controller 130 also includes an operation I/F 305, a control I/F 306, an image data I/F 307, and a network I/F 308. These hardware components of the print server controller 130 are communicably connected to each other via a system bus 309.

The CPU 301 is a computer that totally controls each of the hardware components connected to the system bus 309 based on a control program stored in the ROM 302 or the HDD 304. The RAM 303 functions as a main memory, a work area, etc. of the CPU 301. Memory capacity of the RAM 303 can be expanded by connecting an optional RAM to an expansion port (not shown). The HDD 304 also stores, for example, a boot program, various applications, font data, a user file, an edit file, and the like. The print server 102 can employ an SD card or a flash memory instead of the HDD 304.

The operation I/F 305 controls image display and reception of a user operation on the operation unit 310. The control I/F 306 is connected to the internal LAN 105 and transmits and receives information necessary for the print control to and from the image forming apparatus 101. The image data I/F 307 is connected to the video cable 106, and transmits the post-RIP image data, which has been subjected to the RIP process by the print server 102, to the image forming apparatus 101. The post-RIP image data may be received via the internal LAN 105. The network I/F 308 is connected to the external LAN 104 and controls communication with the client PC 103 or the like. The print server 102 may has a function to transmit a print job as with the client PC 103 described later. In such a case, transmission of a print job is instructed from the operation unit 310 to the print server controller 130 via the print management application.

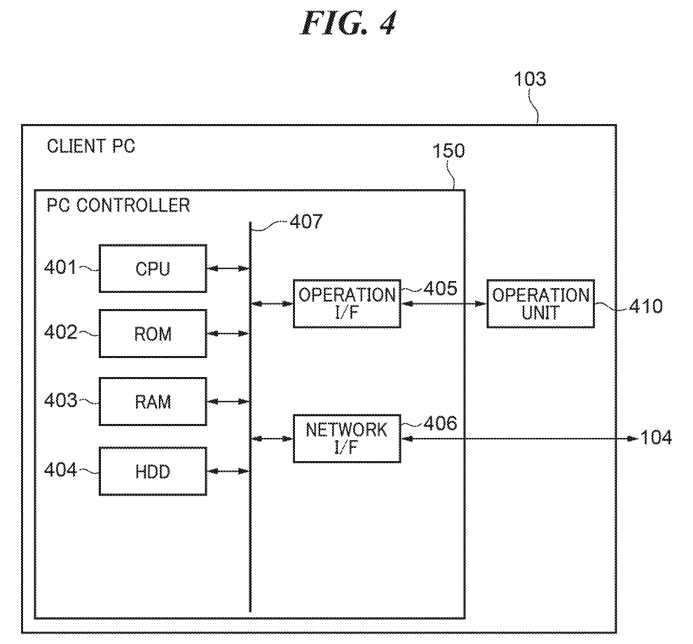

FIG. 4 is a block diagram illustrating an example of a hardware configuration of the client PC 103. As shown in FIG. 4, the client PC 103 includes a PC controller 150 and an operation unit 410, which are communicably connected to each other. The operation unit 410 receives various operations to the client PC 103 and displays information about the client PC 103. When receiving a print instruction from an application, the PC controller 150 can convert a page to be printed into a printer language that can be interpreted by the printer controller 110 of the image forming apparatus 101 via the printer driver.

The PC controller 150 includes a CPU 401, a ROM 402, a RAM 403, an HDD 404, an operation I/F 405, and a network I/F 406, which are communicably connected to each other via a system bus 407. The CPU 401 is a computer that totally controls each of the hardware components connected to the system bus 407 based on a control program stored in the ROM 402 or the HDD 404. The RAM 403 functions as a main memory, a work area, etc. of the CPU 401. Memory capacity of the RAM 403 can be expanded by connecting an optional RAM to an expansion port (not shown).

The HDD 404 also stores, for example, a boot program, various applications, font data, a user file, an edit file, and the like. The client PC 103 can employ an SD card or a flash memory instead of the HDD 404. The operation I/F 405 controls image display and reception of a user operation on the operation unit 410. The network I/F 406 is connected to the external LAN 104 and controls communication with the image forming apparatus 101, the print server 102, and the like.

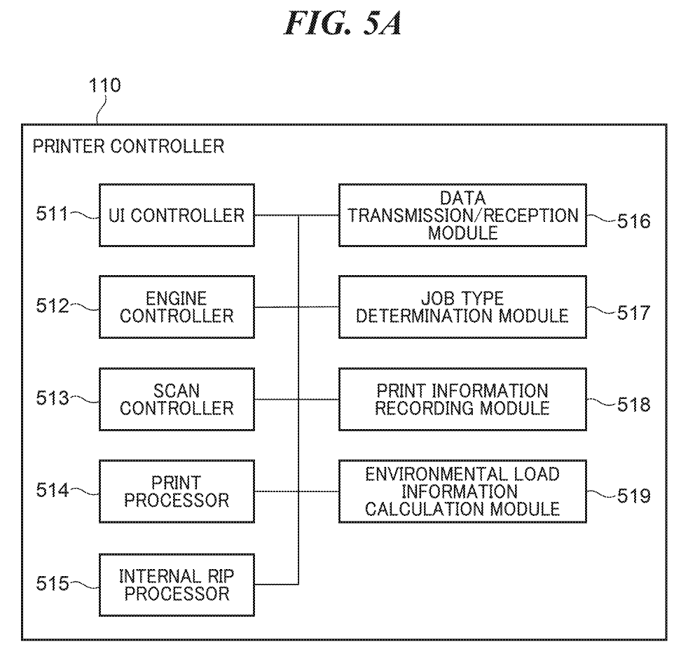

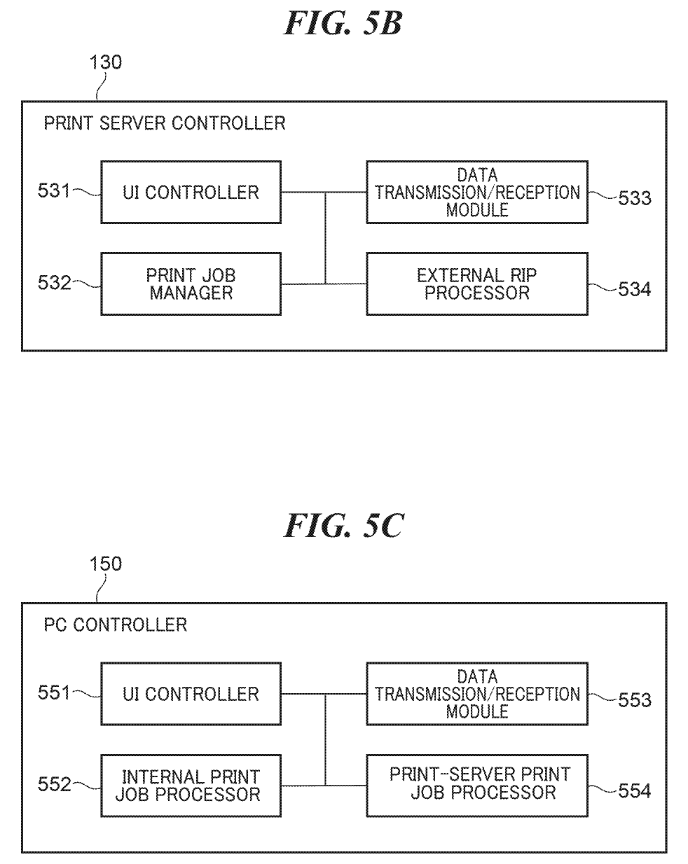

FIG. 5A, FIG. 5B, and FIG. 5C are block diagrams illustrating examples of software configurations of the image forming system. FIG. 5A is a block diagram illustrating an example of a software configuration of the printer controller 110 of the image forming apparatus 101. FIG. 5B is a block diagram illustrating an example of a software configuration of the print server controller 130 of the print server 102. FIG. 5C is a block diagram illustrating an example of a software configuration of the PC controller 150 of the client PC 103.

As shown in FIG. 5A, the printer controller 110 of the image forming apparatus 101 includes a UI controller (a control unit) 511, an engine controller 512, a scan controller 513, a print processor 514, and an internal RIP processor (an RIP processing unit) 515. The printer controller 110 includes a data transmission/reception module 516, a job type determination module 517, a print information recording module 518, and an environmental load information calculation module (an information generating unit) 519. These software modules included in the printer controller 110 are stored as programs in the HDD 204, and are read to the RAM 203 and executed by the CPU 201.

The UI controller 511 controls the image display and reception of a user operation on the operation unit 226 via the operation I/F 210. The engine controller 512 controls a series of printing operations in the printer 221. The print job is processed and executed on a page-by-page basis. The engine controller 512 also controls the finisher 223, the feeder 224, and the stacker 225 that operate in conjunction with the printer 221. The scan controller 513 controls a series of scanning operations in the scanner 222. When the user operates to instruct execution of a job, such as a copy job, a scan-to-send job, or a scan-to-box job, the scan controller 513 controls the scanner 222 to execute the scan process. The image data generated by the scan process is stored in the ROM 202 or the HDD 204.

The print processor 514 executes the print process necessary for the image forming apparatus 101 on the post-RIP print job data. The print processor 514 executes a tone correction process, a halftone process, and the like to generate data printable by the printer 221. The internal RIP processor 515 executes the RIP process on the print data that is received from the client PC 103 and is converted into the printer language (pre-RIP data), and generates data that can be subjected to the print process by the print processor 514. The RIP process executed by the internal RIP processor 515 may be referred to as an “internal RIP process”.

The data transmission/reception module 516 controls data transmission/reception with the print server 102 and the client PC 103. The data from the print server 102 is not particularly limited and may be post-RIP print job data. The data from the client PC 103 is not particularly limited and may be pre-RIP print job data.

The job type determination module 517 determines a type of a print job to be printed by the image forming apparatus 101. In the present embodiment, the print job is received from the client PC 103 and subjected to the internal RIP process in the image forming apparatus 101, for example. A copy job that continuously uses the scanner 222 and the printer 221 may also be a target of the internal RIP process.

The print information recording module 518 records history information about a print job executed by the image forming apparatus 101. The environmental load information calculation module 519 generates (calculates) first operating information and second operating information about the image forming apparatus 101 described later based on the history information about the print job recorded by the print information recording module 518.

As shown in FIG. 5B, the print server controller 130 of the print server 102 includes a UI controller 531, a print job manager 532, a data transmission/reception module 533, and an external RIP processor 534. These software modules included in the print server controller 130 are stored as programs in the HDD 304 and are read to the RAM 303 and executed by the CPU 301.

The UI controller 531 controls the image display and reception of a user operation on the operation unit 310 via the operation I/F 305. The print job manager 532 manages print job data. Specifically, the print job manager 532 performs processes, such as calling of a print job stored in the HDD 304, reflection of a change in a print job setting, and management of a history of a printed job. In general, there is a print management application in order for a user to easily execute a series of processes.

The data transmission/reception module 533 controls transmission/reception of data to/from the image forming apparatus 101. The data transmission/reception module 533 transmits the print job data generated by the external RIP processor 534 to the image forming apparatus 101. The data transmission/reception module 533 also controls data transmission/reception with the client PC 103. The external RIP processor 534 executes the RIP process on the print job instructed to be printed by the print management application, and generates data that can be printed by the print processor 514. The RIP process executed by the print server 102 may be referred to as an “external RIP process”.

As shown in FIG. 5C, the PC controller 150 of the client PC 103 includes an UI controller 551, an internal print job processor 552, a data transmission/reception module 553, and a print-server print job processor 554. These software modules included in the PC controller 150 are stored as programs in the HDD 404, and are read to the RAM 403 and executed by the CPU 401. The UI controller 551 controls the image display and reception of a user operation on the operation unit 410 via the operation I/F 405. The internal print job processor 552 processes the print job data via the printer driver of the client PC 103. Specifically, the internal print job processor 552 interprets the print setting received by the UI controller 551 and converts the page to be printed into the printer language that can be interpreted by the printer controller 110 of the image forming apparatus 101.

The data transmission/reception module 553 controls transmission/reception of data to/from the image forming apparatus 101. The data transmission/reception module 533 transmits the print job data generated by the internal print job processor 552 to the image forming apparatus 101. The data transmission/reception module 553 also controls transmission/reception of data to/from the print server 102. The print-server print job processor 554 executes a print job process for performing the external RIP process in the print server 102. The print-server print job processor 554 performs the process via the print management application installed in the client PC 103.

In the present embodiment, the image forming system 1000 is used in an office document printing operation and an in-house printing operation. Hereinafter, the office document printing operation and the in-house printing operation will be described. The office document printing operation is a printing operation under a first print condition that is capable of printing printed matter mainly used for private use. The office document printing operation is not particularly limited, and may be a printing operation to print printed matter that an employee (user) who works in a company (corporation) such as a general office uses in regular duties. The printed matter in this case is not particularly limited, and may be printed matter that is temporarily used such as materials for presentation and review materials for circulation in a department. Such printed matter tends to omit post-processing such as bookbinding and to be preferable to suppress the use of resources for printing by giving priority to global environment and energy saving even if the print quality relatively lowers. In the office document printing operation, printing is performed using the printer driver installed in the client PC 103.

The in-house printing operation is a printing operation under a second print condition that is capable of printing printed matter mainly used more publicly rather than the office document printing operation. The in-house printing operation is not particularly limited, and may be a printing operation to print printed matter by an operation of an operator who is familiar with the printing operation. The printed matter in this case is not particularly limited, and may be printed matter that is externally distributed and sold, such as business cards and pamphlets. Such printed matter tends to be subjected to post-processing depending on a type of the printed matter and to require relatively high print quality. In the in-house printing operation, printing is performed using the print server 102 connected to the image forming apparatus 101. The printing using the print server 102 allows more kinds of settings and processes such as a print setting, an image process, a color adjustment process, and a finishing process than the printing using the printer driver in the client PC 103.

As described above, the office document printing operation and the in-house printing operation are different in the purpose of use of the printed matter. As described above, the office document printing operation is performed using the printer driver, and the in-house printing operation is performed using the print server 102. Therefore, the print job using the printer driver is managed as a print job on which the internal RIP process is executed for the office document printing operation. On the other hand, the print job using the print server 102 is managed as a print job that has been subjected to the external RIP process for the in-house printing operation.

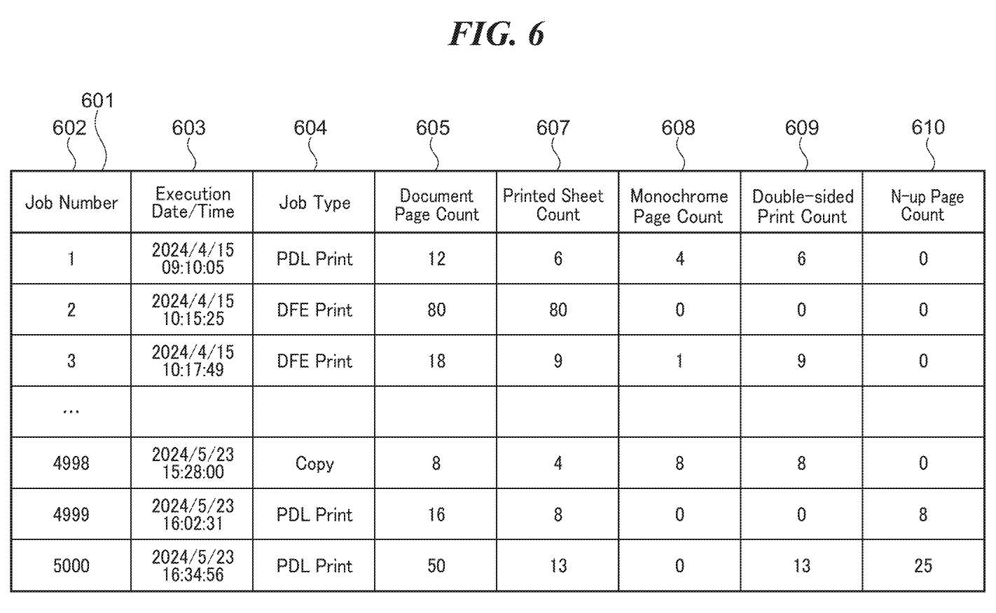

FIG. 6 is a view illustrating an example of a table in which pieces of information related to print jobs recorded by the print information recording module 518 of the image forming apparatus 101 are summarized. The pieces of information included in the table 601 shown in FIG. 6 are recorded in the HDD 204 by the print information recording module 518 as history information about the print jobs in executing printing. The table 601 includes a job number 602, an execution date/time 603, a job type 604, a document page count 605, a printed sheet count 607, a monochrome page count 608, a double-sided print count 609, and a N-up page count 610.

The job number 602 is a serial number assigned to each job, and is given in the order of execution of the jobs. The execution date/time 603 indicates the date and time when each print job is executed. The execution date/time 603 is represented by, for example, year, month, day, hour, minute, and second. In the job type 604, “PDL Print” corresponds to a print job of the office document printing operation, “DEF Print” corresponds to a print job of the in-house printing operation, and “Copy” means a copy job.

The document page count 605 indicates the number of pages of a document file. The printed sheet count 607 indicates the number of sheets that have been actually printed. The monochrome page count 608 indicates the number of pages printed in a monochrome print setting. The double-sided print count 609 indicates the number of sheets printed in a double-sided print setting. In a print job, a predetermined number of pages can be collected, that is, arranged, on one page of a sheet used for printing in the image forming apparatus 101. The N-up page count 610 indicates the number of N-up pages. An N-up page includes a plurality of document pages that are collected and printed.

The environmental load information calculation module 519 can generate the first operating information and the second operating information about the image forming apparatus 101 using the values listed in the table 601 (an information generation step). The first operating information relates to an operation status of the image forming apparatus 101 under the office document printing operation. The first operating information includes environmental load information related to the environmental load of the image forming apparatus 101 during the office document printing operation. The second operating information relates to an operation status of the image forming apparatus 101 under the in-house printing operation. The second operating information includes environmental load information related to the environmental load of image forming apparatus 101 during the in-house printing operation.

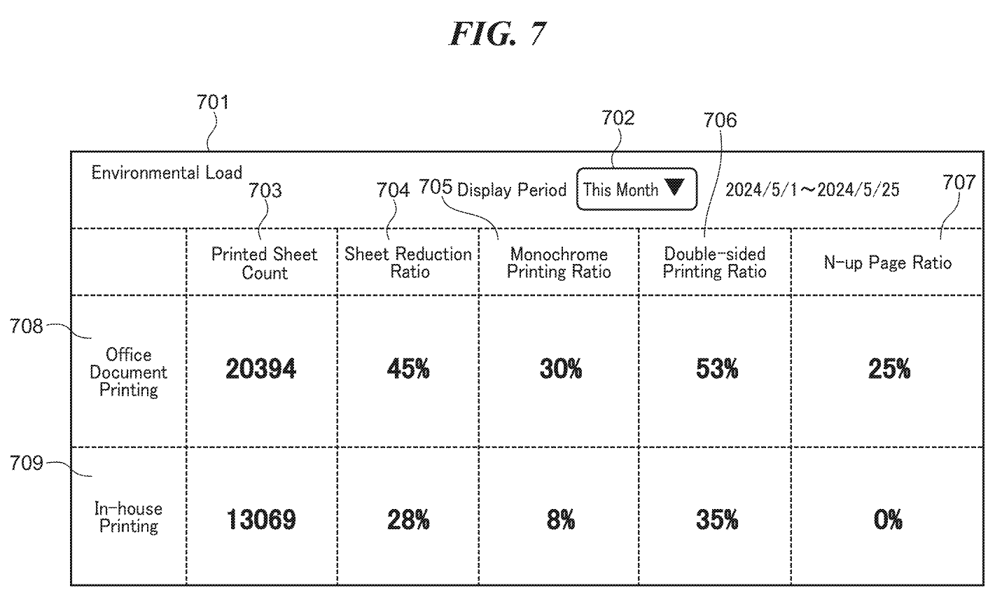

FIG. 7 is a view illustrating an example of an environmental load information screen displayed in the image forming apparatus. The environmental load information screen (an operating information screen) 701 shown in FIG. 7 is displayed on the operation unit 226 under control of the UI controller 511. The environmental load information screen 701 includes, as the pieces of environmental load information, a display period 702, a printed sheet count 703, a sheet reduction ratio 704, a monochrome printing ratio 705, a double-sided printing ratio 706, and an N-up page ratio 707. The contents of the pieces of environmental load information are not limited to the display period 702 to the N-up page ratio 707, and it is preferable that at least one of these contents is included. On the environmental load information screen 701, the environmental load information due to the office document printing operation 708 and the environmental load information due to the in-house printing operation 709 are separately displayed.

The display period 702 indicates a period in which the pieces of environmental load information are totalized and displayed. In the present embodiment, the display period 702 can be switched in a pull-down manner, for example, to this month, this week, today, last month, etc. The printed sheet count 703 indicates the total number of sheets printed within the period set in the display period 702. For example, when the print jobs having job numbers “1”, “2”, and “3” in the table 601 are totalized, the printed sheet count 703 in the office document printing operation 708 becomes “6” corresponding to the job number “1”, and the printed sheet count 703 in the in-house printing operation 709 becomes “89 (=80 + 9)” corresponding to the job numbers “2” and “3”.

The sheet reduction ratio 704 indicates a reduction ratio of sheets used for printing in the image forming apparatus 101 within the period set in the display period 702. The sheet reduction ratio is calculated by ((total printed page count - total printed sheet count)/total printed page count) × 100 using values of the document page count 605 and the printed sheet count 607. The higher the sheet reduction ratio is, the less the number of sheets used is, which contributes to reduction in environmental load. For example, when the print job having job number “1” in the table 601 is a totalizing target, the sheet reduction ratio becomes 50% (=((12 - 6)/12) × 100).

The monochrome printing ratio 705 is a ratio of the number of monochrome print pages to the number of total pages printed with the image forming apparatus 101 within the period set in the display period 702. The monochrome printing ratio is calculated by (total monochrome page count/total printed page count) × 100 using values of the document page count 605 and the monochrome page count 608. The higher the monochrome printing ratio is, the less the consumption of color tonner or color ink is, which contributes to reduction in environmental load. For example, when the print job having job number “1” in the table 601 is a totalizing target, the monochrome printing ratio becomes 33.3% (=(4/12) × 100).

The double-sided printing ratio 706 is a ratio of the number of double-sided printed sheet to the number of total sheets printed with the image forming apparatus 101 within the period set in the display period 702. The double-sided printing ratio is calculated by (total double-sided print count/total printed sheet count) × 100 using the printed sheet count 607 and the double-sided print count 609. The higher the double-sided printing ratio is, the less the number of sheets used is, which contributes to reduction in environmental load. For example, when the print job having job number “1” in the table 601 is a totalizing target, the double-sided printing ratio becomes 100% (=(6/6) × 100).

The N-up page ratio 707 is a ratio of the number of N-up pages (collected pages) to the number of pages printed with the image forming apparatus 101 within the period set in the display period 702. The N-up page ratio is calculated by (total N-up page count/(total printed sheet count + total double-sided print count)) × 100 using the printed sheet count 607, the double-sided print count 609, and the N-up page count 610. The higher the N-up page ratio is, the less the number of sheets used is, which contributes to reduction in environmental load. For example, when the print job having job number “4999” in the table 601 is a totalizing target, the N-up page ratio becomes 100% (=(8/(8 + 0)) × 100). Further, when the print job having job number “5000” in the table 601 is a totalizing target, the N-up page ratio becomes 96.2% (=(25/(13 + 13)) × 100).

Although the environmental load information screen 701 illustrated in FIG. 7 includes the items from the printed sheet count 703 to the N-up page ratio 707, this is not limited. For example, the image forming apparatus 101 may be configured so as to select at least one of the items from the printed sheet count 703 and the N-up page ratio 707 as needed. Accordingly, for example, the environmental load information required by each user can be displayed on the environmental load information screen 701.

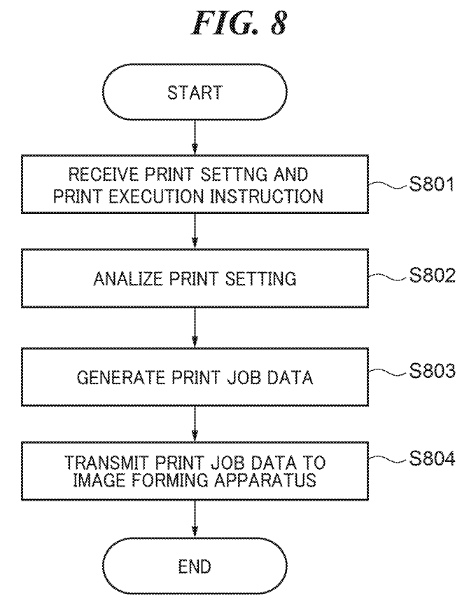

FIG. 8 is a flowchart illustrating a process executed by the client PC during the office document printing operation. A program based on the flowchart shown in FIG. 8 is stored in the HDD 404 of the client PC 103. The CPU 401 of the client PC 103 executes the program by loading it from the HDD 404 to the RAM 403. The program is started by receiving a print execution instruction from the printer driver to print data such as a document and a photograph opened in a word processing application.

The printer driver generates a print job described in the PDL based on document data received from the word processing application in the client PC 103, for example. The PDL is an abbreviation of a page description language such as PS, PCL, or LIPS (registered trademark). As shown in FIG. 8, in a step S801, the CPU 401 of the client PC 103 receives a print setting necessary in printing data of a document or a photograph opened in the word processing application using the printer driver and a print execution instruction.

In a step S802, the CPU 401 analyzes the contents of the print setting received in the step S801. Specifically, the CPU 401 analyzes the setting of a print sheet used in printing, the number of copies, the setting of single-sided printing or double-sided printing, the setting of color printing or monochrome printing, the N-up setting, and the like.

In a step S803, the CPU 401 generates print job data in the internal print job processor 552 based on the analysis result in the step S802. Specifically, the CPU 401 generates PDL data that can be interpreted by the printer controller 110 of the image forming apparatus 101.

The CPU 401 transmits the print job data generated in the step S803 to the image forming apparatus 101 via the data transmission/reception module 553 in a step S804 and ends the process.

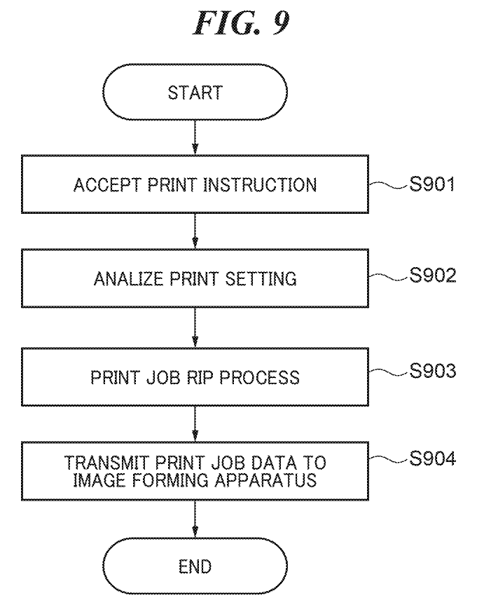

FIG. 9 is a flowchart illustrating a process executed by the print server during the in-house printing operation. A program based on the flowchart shown in FIG. 9 is stored in the HDD 304 of the print server 102. The CPU 301 of the print server 102 executes the program by loading it from the HDD 304 to the RAM 303. The program is started by receiving a print execution instruction from the print server controller 130 to print data such as print PDF data input to the print management application. The print management application is provided by the manufacturer of the print server 102. The print server controller 130 can execute various settings and processes such as a print setting, an image process, a color adjustment process, and a finishing process necessary for performing the in-house printing operation.

As shown in FIG. 9, in a step S901, the CPU 301 receives a print setting necessary in printing the print PDF data input to the print management application using the print server controller 130 and a print execution instruction. This reception operation is performed with the operation unit 310 of the print server 102, but this is not limited, and can be performed with the operation unit 410 of the client PC 103, for example.

In a step S902, the CPU 301 analyzes the contents of the print setting received in the step S801. Specifically, the CPU 301 analyzes the setting of a print sheet used in printing, the number of copies, the setting of an output layout, the setting of color printing or monochrome printing, the setting of image quality adjustment, and the like.

In a step S903, the CPU 301 executes an external RIP process with the external RIP processor 534 based on the analysis result in the step S902. Accordingly, the print PDF data in a vector format input to the print management application is converted into data in a raster format that can be subjected to the print process by the image forming apparatus 101.

The CPU 301 transmits the data subjected to the external RIP process in the step S902 to the image forming apparatus 101 via the data transmission/reception module 533 in a step S904, and ends the process.

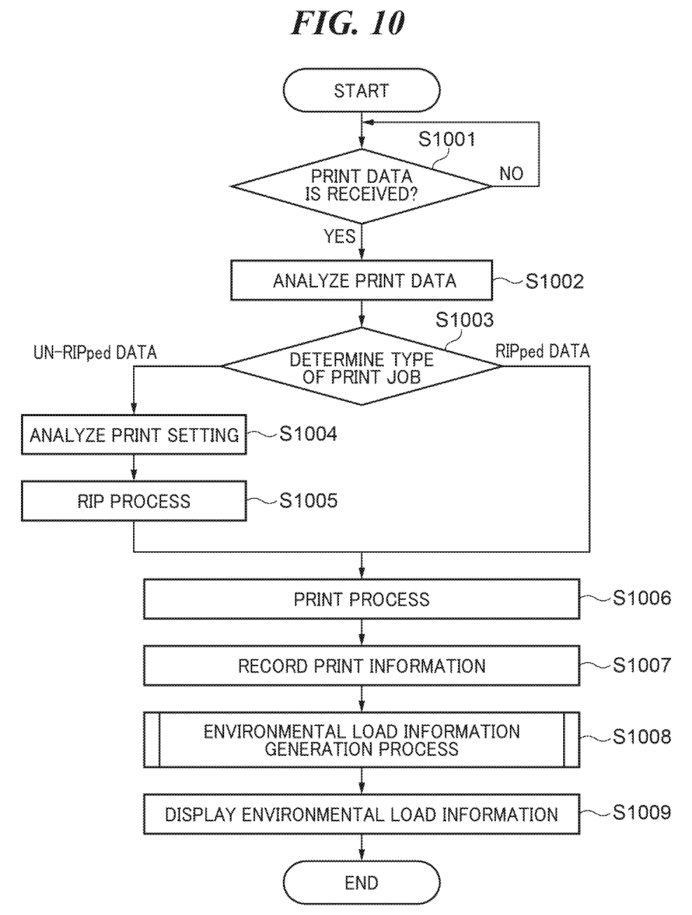

FIG. 10 is a flowchart illustrating a process executed by the image forming apparatus. A program based on the flowchart shown in FIG. 10 is stored in the HDD 204 of the image forming apparatus 101. The CPU 201 of the image forming apparatus 101 executes the program by loading it from the HDD 204 to the RAM 203. The program is started by receiving print data (a print job) from the client PC 103 or the print server 102 via the data transmission/reception module 516.

As illustrated in FIG. 10, in a step S1001, the CPU 201 of the image forming apparatus 101 determines whether the data transmission/reception module 516 receives the print data from the client PC 103 or the print server 102. As described above, in the present embodiment, the data transmission/reception module 516 functions as an obtaining unit capable of obtaining the print data to be printed (an obtaining step). Then, as a result of the determination in the step S1001, when it is determined that the print data is received, the process proceeds to a step S1002. On the other hand, as a result of the determination in the step S1001, when it is determined that the print data is not received, the process waits in the step S1001.

In the step S1002, the CPU 201 analyzes the print data received in the step S1001. Specifically, the CPU 201 obtains information that contributes to determination in the next step S1003, such as input route information about the print data to the data transmission/reception module 516 and a format of the print data.

In the step S1003, the CPU 201 determines the type of the print job including the print data by the job type determination module 517 based on the analysis result in the step S1002. Specifically, when printing the print data, the CPU 201 determines whether to print the print data by the office document printing operation or the in-house printing operation (a determination step). As described above, in the present embodiment, the CPU 201 also functions as a determination unit that determines whether to print the print data by the office document printing operation or the in-house printing operation. In the image forming apparatus 101, a section functioning as the determination unit may be provided separately from the CPU 201. This determination is performed based on whether the print data (print job) obtained with the data transmission/reception module 516 is post-RIP data, that is, data that has been subjected to the RIP process.

In the present embodiment, when the print data is transmitted from the client PC 103 via the external LAN 104 and is received with the network I/F 213, it is determined that the print data is not the post-RIP data, that is, it is pre-RIP data. In addition, when the print data is transmitted from the print server 102 via the internal LAN 105 and is received with the job control I/F 211, it is determined that the print data is the post-RIP data.

Similarly, when the print data is transmitted from the print server 102 via the video cable 106 and received with the image data I/F 212, the print data is determined as the post-RIP data. When it is determined that the print data is the pre-RIP data, the process proceeds to a step S1004, and the data is processed by the office document printing operation. On the other hand, when it is determined that the print data is the post-RIP data, the process proceeds to a step S1006, and the data is processed by the in-house printing operation.

In the step S1004, the CPU 201 analyzes the print setting (print condition) included in the print data received in the step S1001. The print setting includes, for example, a setting of a print sheet used in printing, the number of copies, a setting of single-sided printing or double-sided printing, a setting of color printing or monochrome printing, a page collection setting, and the like.

In a step S1005, the CPU 201 executes the internal RIP process by the internal RIP processor 515 based on the analysis result in the step S1004. As a result, the print data is converted into the post-RIP data.

In the step S1006, the CPU 201 controls the printer 221, the finisher 223, the feeder 224, and the stacker 225 with the print processor 514 to perform the print process on the post-RIP print data. This provides the printed matter resulted from the office document printing operation or the printed matter resulted from the in-house printing operation.

In a step S1007, the CPU 201 records the history information (see FIG. 6) about the print job at the time of execution of the print process in the step S1006 in the HDD 204 with the print information recording module 518.

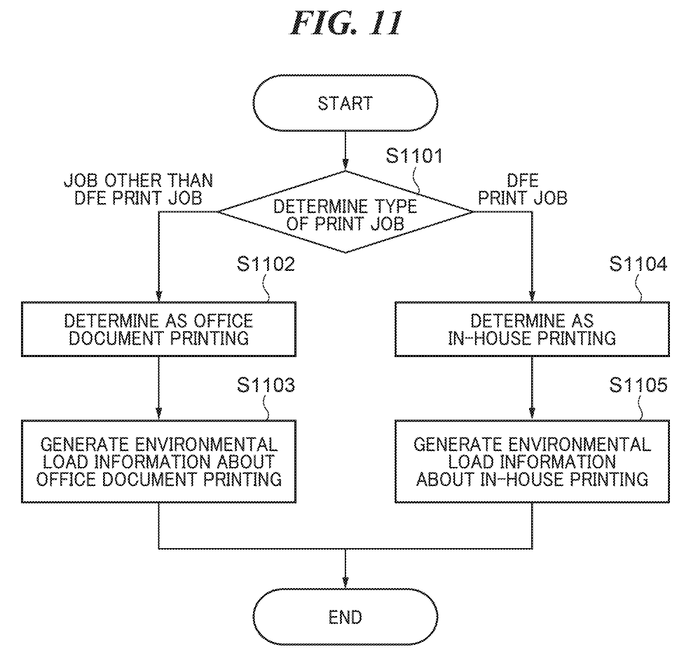

In a step S1008, the CPU 201 generates the environmental load information with the environmental load information calculation module 519 based on the history information recorded in the step S1007. The details of the process in the step S1008, that is, the environmental load information generation process, will be described later with reference to FIG. 11.

In a step S1009, the CPU 201 displays the environmental load information generated in the step S1008 on the operation unit 226. That is, the CPU 201 generates the environmental load information screen 701 (see FIG. 7) with the UI controller 511 based on the environmental load information and displays the environmental load information screen 701 on the operation unit 226. The environmental load information screen 701 notifies the user of the environmental load information under the office document printing operation (first operating information) and the environmental load information under the in-house printing operation (second operating information), and thus the user can understand these pieces of information. After the step S1009 is executed, the process is terminated.

FIG. 11 is a flowchart illustrating the process executed in the step S1008 (a subroutine) in the flowchart illustrated in FIG. 10. As illustrated in FIG. 11, in a step S1101, the CPU 201 of the image forming apparatus 101 discriminates (determines) the type of the print job (job type 604) included in the history information recorded in the step S1007 with the job type determination module 517. In the present embodiment, it is determined whether the type of the job is the DEF print job (in-house printing operation) or other than the DEF print job, that is, the PDL print job (office document printing operation) or the like. As a result of the determination in the step S1101, when it is determined that the print job is other than the DEF print job, the process proceeds to a step S1102. On the other hand, as a result of the determination in the step S1101, when it is determined that the print job is the DEF print job, the process proceeds to a step S1104.

In the step S1102, the CPU 201 determines that the print data has been printed by the office document printing operation in the print process in the step S1006.

The CPU 201 generates the environmental load information (first operating information) about the image forming apparatus 101 under the office document printing operation with the environmental load information calculation module 519 in a step S1103 and ends the process.

In the step S1104, the CPU 201 determines that the print data has been printed by the in-house printing operation in the print process in the step S1006.

The CPU 201 generates the environmental load information (second operating information) about the image forming apparatus 101 under the in-house printing operation with the environmental load information calculation module 519 in a step S1105 and ends the process.

As described above, the image forming apparatus 101 is capable of separating the environmental load information about the office document printing operation and the environmental load information about the in-house printing operation, which have different printing purposes, for example. The environmental load information about the office document printing operation and the environmental load information about the in-house printing operation are collectively displayed on the environmental load information screen 701. This enables the user to understand each piece of information, thereby contributing to an improvement in consciousness of the user for reducing the environmental load. The environmental load information calculation module 519 may omit the generation of the environmental load information about the in-house printing operation. This is because it is often preferable to display the environmental load information about the office document printing operation in preference to the environmental load information about the in-house printing operation. The reason is that the office document printing operation tends to have a larger room for reduction of the environmental load than the in-house printing operation.

Depending on the use environment of the image forming system 1000, there can be multiple types of office document printing operations (i.e., multiple types of first print conditions) corresponding to various users. Similarly, there can be multiple types of in-house printing operations (i.e., multiple types of second print conditions) corresponding to various users. In such a case, the environmental load information calculation module 519 can generate the environmental load information under the multiple types of office document printing operations collectively. Similarly, the environmental load information calculation module 519 can generate the environmental load information under the multiple types of in-house printing operations collectively. With this configuration, for example, the various users in the entire office who use the image forming apparatus 101 can understand the environmental load information under the office document printing operations and the environmental load information under the in-house printing operations.

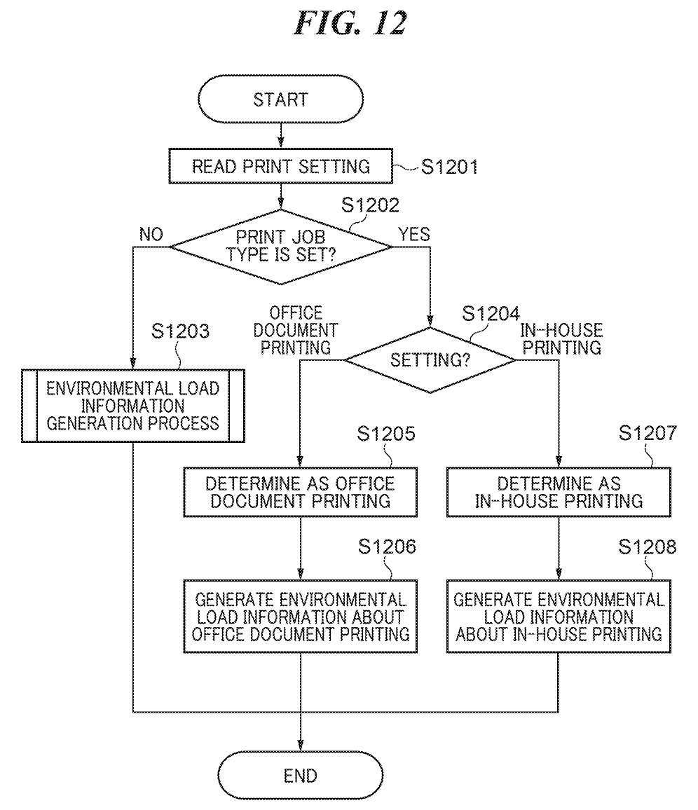

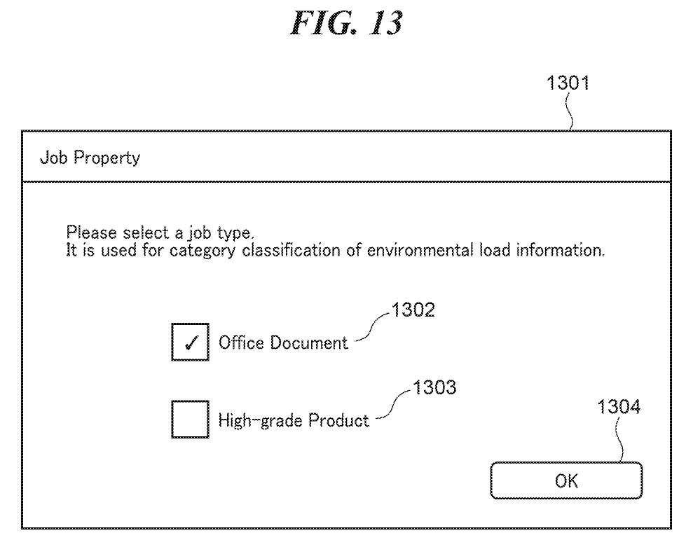

Hereinafter, a second embodiment will be described with reference to FIG. 12 and FIG. 13. Differences from the above-described embodiment will be mainly described, and the description of the same configuration will be omitted. In the first embodiment, the printing by the office document printing operation is performed using the printer driver installed in the client PC 103 and the printing in the in-house printing operation is performed using the print server 102 connected to the image forming apparatus 101. In contrast, the printing by the office document printing operation may be performed using the print server 102 and the printing in the in-house printing operation may be performed using the printer driver installed in the client PC 103 depending on the use environment of the image forming system 1000. The image forming system 1000 in such a case will be described in the present embodiment.

FIG. 12 is a flowchart illustrating a process executed by the image forming apparatus related to the second embodiment. The flowchart in FIG. 12 illustrates a variation example of the process executed in the step S1008 (subroutine) in the flowchart in FIG. 10. As illustrated in FIG. 12, in a step S1201, the CPU 201 of the image forming apparatus 101 reads print setting information about a print job including print data that is an execution target of the print process in the step S1006.

In a step S1202, the CPU 201 determines whether there is information (setting) about a print job type in the print setting information read in the step S1201. Here, the information about the print job type indicates whether the print data is printed by the office document printing operation or the in-house printing operation. As a result of the determination in the step S1202, when it is determined that there is no information about the print job type, the process proceeds to a step S1203. On the other hand, as a result of the determination in the step S1202, when it is determined that there is the information about the print job type, the process proceeds to a step S1204.

In the step S1203, the CPU 201 generates the environmental load information with the environmental load information calculation module 519 as in the step S1008. After the step S1203 is executed, the process is terminated.

In the step S1204, the CPU 201 determines whether to print by the office document printing operation or the in-house printing operation. This determination is made based on a setting content on a print setting screen 1301 (see FIG. 13) described later. As a result of the determination in the step S1204, when it is determined to print by the office document printing operation, the process proceeds to a step S1205. On the other hand, as a result of the determination in the step S1204, when it is determined to print by the in-house printing operation, the process proceeds to a step S1207.

In the step S1205, the CPU 201 determines that the print data has been printed by the office document printing operation as in the step S1102.

In a step S1206, the CPU 201 generates the environmental load information about the image forming apparatus 101 under the office document printing operation with the environmental load information calculation module 519 as in the step S1103. After the step S1206 is executed, the process is terminated.

In the step S1207, the CPU 201 determines that the print data has been printed by the in-house printing operation as in the step S1104.

In a step S1208, the CPU 201 generates the environmental load information about the image forming apparatus 101 under the in-house printing operation with the environmental load information calculation module 519 as in the step S1105. After the step S1208 is executed, the process is terminated.

FIG. 13 is a view illustrating an example of the print setting screen. The print setting screen 1301 shown in FIG. 13 is displayed on the client PC 103 and the print server 102. When the print setting screen 1301 is displayed on the client PC 103, the print setting screen 1301 is used for the print job setting of the printer driver of the client PC 103. This print job setting is received in the step S801. When the print setting screen 1301 is displayed on the print server 102, the print setting screen 1301 is used for the print job setting of the print management application of the print server 102. This print job setting is received in the step S901.

The print setting screen 1301 includes checkboxes 1302 and 1303, and an OK button 1304. By checking the checkbox 1302, with the image forming apparatus 101 can print the target print data by the office document printing operation. By checking the checkbox 1303, the image forming apparatus 101 can print the target print data by the in-house printing operation that is capable of printing a high-quality product (printed matter). Then, when the user presses the OK button 1304 in a state where one of the checkboxes 1302 and 1303 is checked, the content selected in the one check box is determined. Also, with this determination, the print setting screen 1301 closes.

One of the check boxes 1302 and 1303 on the print setting screen 1301 may be checked in advance in an initial state. In this case, if the print setting screen 1301 is displayed on the client PC 103, it is preferable that the checkbox 1302 is checked in advance. When the print setting screen 1301 is displayed on the print server 102, it is preferable that the checkbox 1303 is checked in advance. Neither the checkbox 1302 nor the checkbox 1303 on the print setting screen 1301 may be checked in the initial state.

As described above, in the present embodiment, the check of the checkbox 1302 and the check of the checkbox 1303 can be switched. Thus, the printing by the office document printing operation can be performed using the print server 102, and the printing by the in-house printing operation can be performed using the printer driver installed in the client PC 103.

According to the present disclosure, the environmental load information about one printing operation and the environmental load information about another printing operation that having different printing purposes can be separated from each other.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-016857, filed February 4, 2025 which is hereby incorporated by reference herein in its entirety.

What is claimed is:

1. An image forming apparatus capable of printing, the image forming apparatus comprising:
a memory device that stores a set of instructions; and
at least one processor that executes the set of instructions to:
obtain data to be printed;
determine whether to print the data under a first print condition or a second print condition that is capable of printing printed matter used more publicly than printed matter printed under the first print condition;
generate first operating information about an operation status of the image forming apparatus under the first print condition in a case where it is determined to print under the first print condition; and
generate second operating information about an operation status of the image forming apparatus under the second print condition in a case where it is determined to print under the second print condition.

2. The image forming apparatus according to claim 1, wherein the first operating information includes environmental load information related to an environmental load of the image forming apparatus under the first print condition,
the second operating information includes environmental load information related to an environmental load of the image forming apparatus under the second print condition.

3. The image forming apparatus according to claim 2, wherein the environmental load information includes at least one of a sheet reduction ratio that is a reduction ratio of sheets used for printing in the image forming apparatus, a monochrome printing ratio in a case where monochrome printing is performed in the image forming apparatus, a double-sided printing ratio in a case where double-sided printing is performed in the image forming apparatus, and an N-up page ratio that is a ratio of the number of N-up pages to the number of pages printed with the image forming apparatus.

4. The image forming apparatus according to claim 3, wherein the sheet reduction ratio, the monochrome printing ratio, the double-sided printing ratio, and the N-up page ratio are selectable as the environmental load information.

5. The image forming apparatus according to claim 1, wherein the at least one processor executes instructions in the memory device to determine whether to print under the first print condition or the second print condition based on whether the data obtained has been subjected to an RIP process.

6. The image forming apparatus according to claim 5, wherein the at least one processor executes instructions in the memory device to determine to print under the second print condition in a case where the data obtained has been subjected to the RIP process, and determine to print under the first print condition in a case where the data obtained has not been subjected to the RIP process.

7. The image forming apparatus according to claim 6, wherein the at least one processor executes instructions in the memory device to perform the RIP process on the data that has not been subjected to the RIP process.

8. The image forming apparatus according to claim 1, wherein the data obtained includes print information about whether to print the data under the first print condition or the second print condition,
wherein the at least one processor executes instructions in the memory device to determine whether to print the data under the first print condition or the second print condition based on the print information.

9. The image forming apparatus according to claim 1, wherein there are multiple types of first print conditions and multiple types of second print conditions,
wherein the at least one processor executes instructions in the memory device to generate the first operating information under the multiple types of first print conditions collectively and generate the second operating information under the multiple types of second print conditions collectively.

10. The image forming apparatus according to claim 1, wherein generation of the second operating information can be omitted.

11. The image forming apparatus according to claim 1, wherein the at least one processor executes instructions in the memory device to control notifying of the first operating information in a case where the first operating information is generated and displaying an operating information screen notifying the second operating information in a case where the second operating information is generated.

12. The image forming apparatus according to claim 1, wherein printed matter used for private use can be printed under the first print condition and printed matter used for public use can be printed under the second print condition.

13. A control method for an image forming apparatus capable of printing, the control method comprising:
obtaining data to be printed;
determining whether to print the data under a first print condition or a second print condition that is capable of printing printed matter used more publicly than printed matter printed under the first print condition;
generating first operating information about an operation status of the image forming apparatus under the first print condition in a case where it is determined to print under the first print condition; and
generating second operating information about an operation status of the image forming apparatus under the second print condition in a case where it is determined to print under the second print condition.

14. A non-transitory computer-readable storage medium storing a control program causing a computer to execute a control method for an image forming apparatus capable of printing, the control method comprising:
obtaining data to be printed;
determining whether to print the data under a first print condition or a second print condition that is capable of printing printed matter used more publicly than printed matter printed under the first print condition;
generating first operating information about an operation status of the image forming apparatus under the first print condition in a case where it is determined to print under the first print condition; and
generating second operating information about an operation status of the image forming apparatus under the second print condition in a case where it is determined to print under the second print condition.
